(19) United States
(12) Patent Application Publication
(10) Pub. No.: US 2007/0136992 A1
(43) Pub. Date: Jun. 21, 2007

(54) Hinge with multiple positioning angles

(75) Inventors: Sheng-Nan Lu, Shulin City (TW); Hsiang-Chi Chien, Shulin City (TW); Chung-Yu Lee, Shulin City (TW)

Correspondence Address: BIRCH STEWART KOLASCH & BIRCH, PO BOX 747, FALLS CHURCH, VA, 22040-0747, US

(73) Assignee: SHIN ZU SHING CO., LTD.

(21) Appl. No.: 11/303,959

(22) Filed: Dec. 19, 2005

(51) Int. Cl. E05D 11/10

(52) U.S. Cl. 16/330

(57) ABSTRACT

A hinge with multiple positioning angles has a shaft, a rotating bracket, a rotating-positioning element, a stationary-positioning element and a stationary bracket. The rotating bracket is mounted around the shaft and is mounted securely in a web camera that is mounted in a cover of a notebook computer. The rotating-positioning element is mounted securely on the rotating bracket and has at least one positioning protrusion. The stationary-positioning element is mounted securely on the shaft and has at least one positioning recess corresponding to the positioning protrusion. Each positioning recess has a detent corresponding to the positioning protrusion. With the positioning protrusion selectively engaging the positioning recess and the detent, the hinge positions the web camera at multiple shot angles and is convenient to position the web camera to shot the frontage of the user.

### BACKGROUND OF THE INVENTION

1. Field of the Invention

The present invention relates to a hinge, especially to a hinge with multiple positioning angles mounted between a web camera and a notebook computer to mount the web camera pivotally on the notebook computer.

2. Description of the Prior Arts

Because of recent developments with the Internet and equipment used on the Internet, the Internet is not limited to the transfer of data, audio and video files but can also transfer real-time audio and video data. Generally, web cameras connect to computers to transfer real-time images. For convenience, a web camera for the notebook computer having a cover and a base is often mounted pivotally on the cover. The cover has a built-in liquid crystal display (LCD). The web camera is attached pivotally to the cover by a hinge. A conventional hinge attaches the web camera perpendicular to the cover to protect the web camera lens when the cover is closed.

However, the preferred visual angle of the LCD to enhance the capabilities of the LCD is greater than 90 degrees relative to the base, such as 110 degrees or 120 degrees. When the angle between the cover and the base is greater than 90 degrees, the web camera may not be centered on the user because the web camera is to the cover. When the web camera is pivoted to place an object not at 90 degrees in the field of view of the web camera, the web camera is unsteady and easily rotates because the conventional hinge only holds the web camera securely perpendicular to the cover. Unstable web cameras are not convenient and may require constant adjustment.

To overcome the shortcomings, the present invention provides a hinge with multiple positioning angles to mitigate or obviate the aforementioned problems.

### SUMMARY OF THE INVENTION

The main objective of the present invention is to provide a hinge with multiple positioning angles. The hinge with multiple positioning angles has a shaft, a rotating bracket, a rotating-positioning element, a stationary-positioning element and a stationary bracket. The rotating bracket is mounted around the shaft and is mounted securely in a web camera that is mounted in a cover of a notebook computer. The rotating-positioning element is mounted securely on the rotating bracket and has at least one positioning protrusion. The stationary-positioning element is mounted securely on the shaft and has at least one positioning recess corresponding to the positioning protrusion. Each positioning recess has a detent corresponding to the positioning protrusion. With the positioning protrusion selectively engaging the positioning recess and the detent, the hinge positions the web camera at multiple shot angles and is convenient to position the web camera to shot the frontage of the user.

Other objectives, advantages and novel features of the invention will become more apparent from the following detailed description when taken in conjunction with the accompanying drawings.

### BRIEF DESCRIPTJON OF THE DRAWINGS

FIG. 1 is a perspective view of a hinge with multiple positioning angles in accordance with the present invention;

FIG. 2 is an exploded perspective view of the hinge in FIG. 1;

FIG. 3 is an exploded perspective view of the hinge in FIG. 1;

FIG. 4 is a side view of a rotating-positioning element of the hinge in FIG. 1;

FIG. 5 is a side view of a stationary-positioning element of the hinge in FIG. 1;

FIG. 6 is a perspective view of a notebook computer with a web camera and the hinge in FIG. 1;

FIG. 7 is a side view of the hinge in FIG. 1;

FIG. 8 is an operational side view in partial section of the hinge in FIG. 1 when the hinge positions the web camera at the shot angle perpendicular to the cover of the notebook computer; and

FIG. 9 is an operational side view in partial section of the hinge in FIG. 1 when the hinge positions the web camera at another shot angle to shot the frontage of the user.

### DETAILED DESCRIPTION OF THE PREFERRED EMBODIMENTS

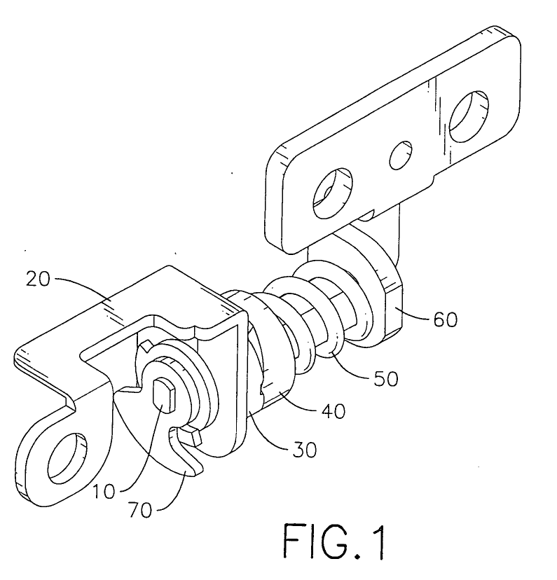

With reference to FIG. 1, a hinge with multiple positioning angles in accordance with the present invention comprises a shaft (10), a rotating bracket (20), a rotating-positioning element (30), a stationary-positioning element (40), a stationary bracket (60), a biasing member (50), an actuating switch (70) and a fastening element (80).

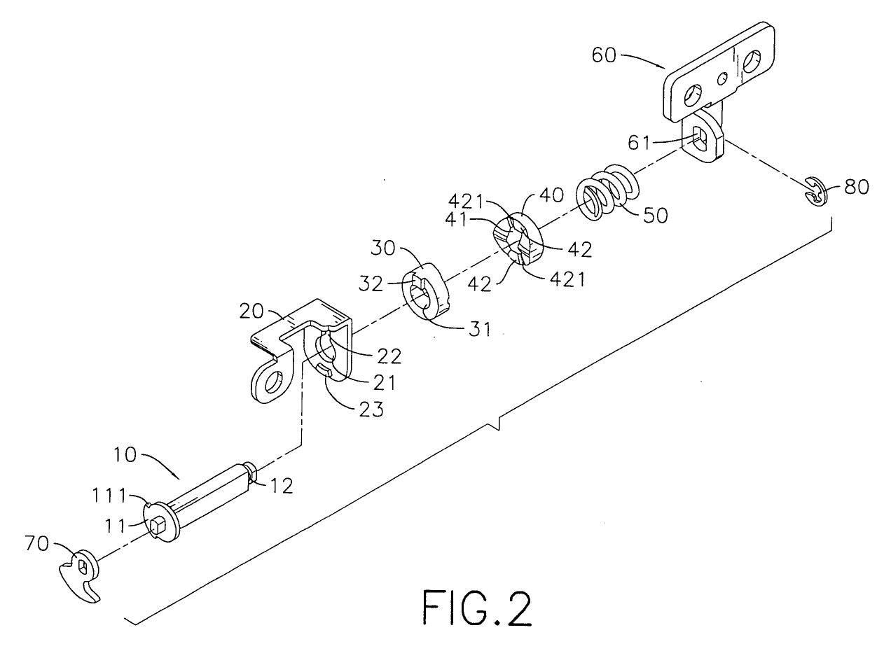

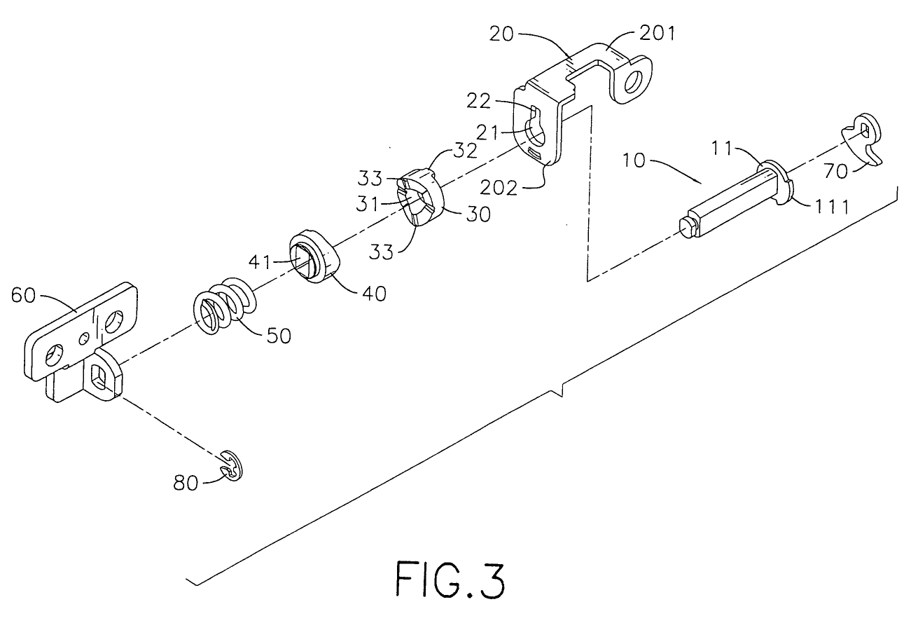

With further reference to FIGS. 2 and 3, the shaft (10) may be non-circular in cross section and has a first end, a second end, a head (11), a sector protruding part (111) and an annular groove (12). The head (11) is formed on the first end of the shaft (10). The sector protruding part (111) is formed on and extends radially out of the head (11). The annular groove (12) is formed around the shaft (10) near the second end of the shaft (10).

The rotating bracket (20) is mounted rotatably on the shaft (10), is L-shaped and has a first leaf (201), a second leaf (202), a circular hole (21), an optional through hole (22) and an optional protrusion (23). The second leaf (202) has an outer surface and an inner surface. The outer surface of the second leaf (202) abuts the head (11) of the shaft (10). The circular hole (21) is formed through the second leaf (202) and is mounted around the shaft (10). The through hole (22) is formed through the second leaf (202) and communicates with the circular hole (21). The protrusion (23) is formed on and extends out of the outer surface of the second leaf (202) and selectively abuts the sector protruding part (111) of the shaft (10) to limit the rotating angle of the rotating bracket (20).

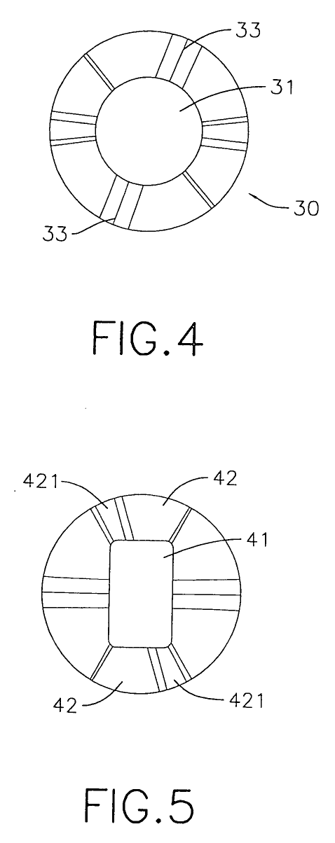

With further reference to FIG. 4, the rotating-positioning element (30) is mounted rotatably around the shaft (10) and is mounted securely on the second leaf (202) of the rotating bracket (20). The rotating-positioning element (30) has an outer surface, an inner surface, a central hole (31), at least one positioning protrusion (33) and an optional fastening protrusion (32). The outer surface of the rotating-positioning element (30) is adjacent to the inner surface of the second leaf (202) of the rotating bracket (20). The central hole (31) is circular and is mounted around the shaft (10). The at least one positioning protrusion (33) is-fornied on and extends axially out of the inner surface of the rotating-positioning element (30). Each positioning protrusion (33) has two inclined sides. The rotating-positioning element (30) may have two positioning protrusions (33) opposite to each other. The fastening protrusion (32) is formed on and extends axially out of the outer surface of the rotating-positioning element (30) and corresponds to and engages with the through hole (22) of the rotating bracket (20) to mount the rotating-positioning element (30) securely on the rotating bracket (20).

With further reference to FIG. 5, the stationary-positioning element (40) is mounted securely on the shaft (10) adjacent to the rotating-positioning element (30) and has an outer surface, an inner surface, a central hole (41) and at least one positioning recess (42). The central hole (41) of the stationary-positioning element (40) is mounted around the shaft (10) and may be non-circular to correspond to the shaft (10) and to mount the stationary-positioning element (40) securely on the shaft (10). The at least one positioning recess (42) is formed on and extends out of the outer surface of the stationary-positioning element (40) and selectively engages the at least one positioning protrusion (33) on the rotating-positioning element (30). Each positioning recess (42) is wider than each positioning protrusion (33) and has two inclined sides and a detent (421). The detent (421) is formed axially in one of the inclined sides of the positioning recess (42) and corresponds to and selectively engages with the positioning protrusion (33) on the rotating-positioning element (30). The stationary-positioning element (40) may have two positioning recesses (42) and the detents (421) in the positioning recesses (42) opposite to each other.

The stationary bracket (60) is mounted securely on the shaft (10) and has a through hole (61). The through hole (61) is mounted on the shaft (10) and may be non-circular to correspond to the shaft (10) and to mount the stationary bracket (60) securely on the shaft (10).

The biasing member (50) is mounted around the shaft (10), respectively abuts the stationary-positioning element (40) and the stationary bracket (60) to press the stationary-positioning element (40) against the rotating-positioning element (30) and may be a spring.

The actuating switch (70) is mounted securely on the first end of the shaft (10) to control a web camera on or off.

The fastening element (80) is mounted around the second end of the shaft (10) to keep the shaft (10) from departing from the stationary bracket (60) axially. The fastening element (80) may be a C-clip and engages with the annular groove (12) of the shaft (10).

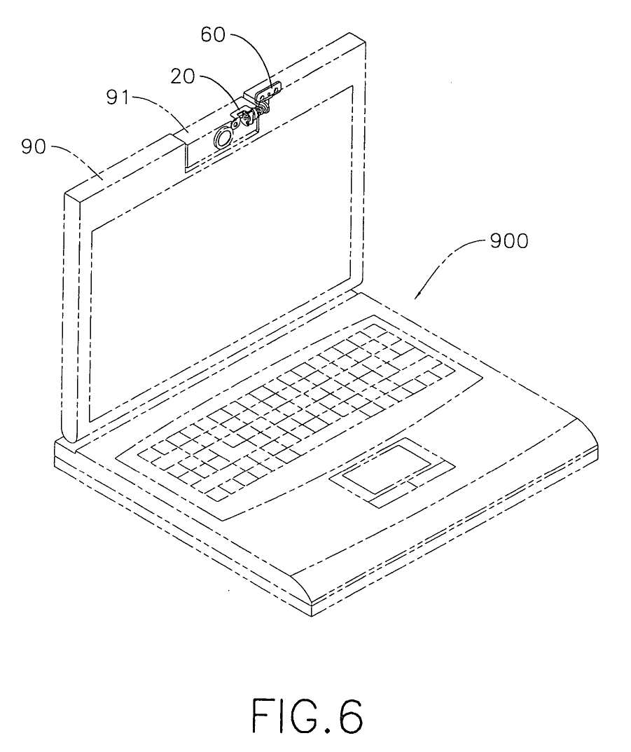

With further reference to FIG. 6, a web camera (91) is mounted pivotally on a cover (90) of a notebook computer (900) by the hinge as described. The rotating bracket (20) is mounted securely in the web camera (91). The stationary bracket (60) is mounted securely in the cover (90).

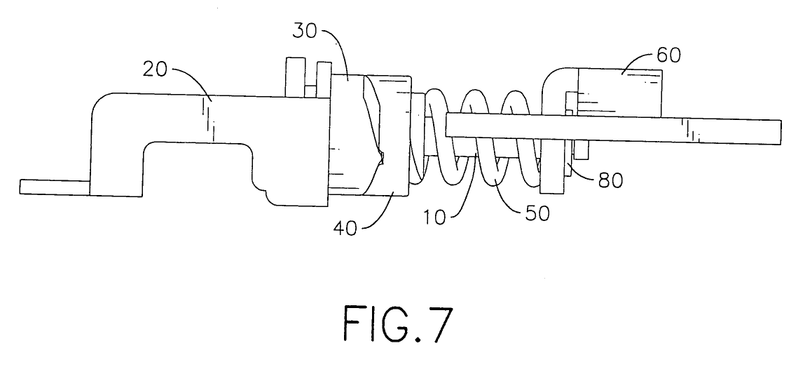

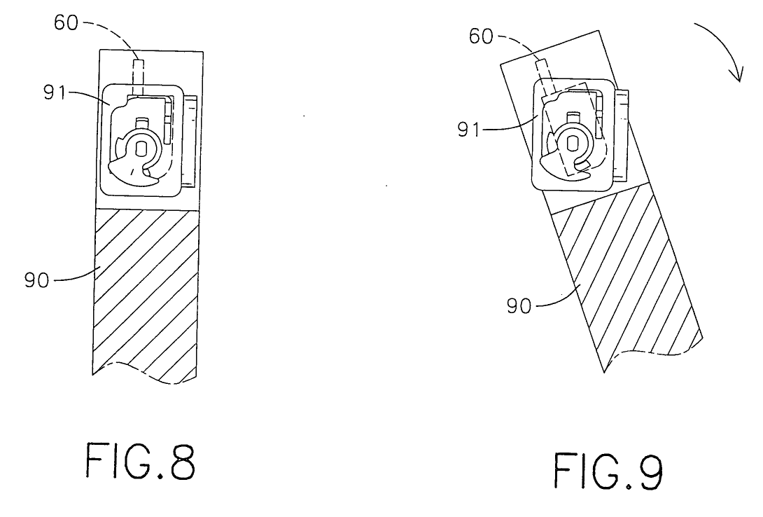

With further reference to FIGS. 7 and 8, when the cover (90) is at a position where perpendicular to a base of the notebook computer (900) and the web camera (91) is rotated, the rotating bracket (20) is rotated with the web camera (91) and rotates the rotating-positioning element (30) with the rotating bracket (20). When the shot angle of the web camera (91) is perpendicular to the cover (90), the positioning protrusion (33) on the rotating-positioning element (30) engages with the positioning recess (42) of the stationary-positioning element (40). Therefore, the hinge positions the web camera (91) at the shot angle of the web camera (91) perpendicular to the cover (90).

With further reference to FIG. 9, if the cover (90) is at a position where not perpendicular to the base of the notebook computer (900), the web camera (90) is rotated to the shot angle that shots the frontage of the user. The positioning protrusion (33) of the rotating-positioning element (30) will engage with the detent (421) of the stationary-positioning element (40). Therefore, the hinge positions the web camera (90) at the shot angle that is not perpendicular to the cover (90) and is convenient to shot the frontage of the user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge with multiple positioning angles comprising:
a shaft;
a rotating bracket mounted rotatably on the shaft, being L-shaped and having
a first leaf;
a second leaf; and
a circular hole formed through the second leaf and mounted around the shaft;
a rotating-positioning element mounted rotatably around the shaft, mounted securely on the second leaf of the rotating bracket and having
an outer surface being adjacent to the inner surface of the second leaf of the rotating bracket;
an inner surface;
a central hole being circular and mounted around the shaft; and
at least one positioning protrusion formed on and extending axially out of the inner surface of the rotating-positioning element, and each positioning protrusion having two inclined sides;
a stationary-positioning element mounted securely on the shaft adjacent to the rotating-positioning element and having
an outer surface;
an inner surface;
a central hole mounted on the shaft; and
at least one positioning recess formed on and extending out of the outer surface of the stationary-positioning element, selectively engaging the at least one positioning protrusion on the rotating-positioning element, and each positioning recess being wider than each positioning protrusion and having
two inclined sides; and
a detent formed axially in one of the inclined sides of the positioning recess and corresponding to and selectively engaging the at least one positioning protrusion on the rotating-positioning element;
a stationary bracket mounted securely on the shaft and having a through hole mounted on the shaft;
a biasing member mounted around the shaft and respectively abutting the stationary-positioning element and the stationary bracket;
an actuating switch mounted securely on a first end of the shaft; and
a fastening element mounted around a second end of the shaft to keep the shaft from departing from the stationary bracket axially.

2. The hinge as claimed in claim 1, wherein
the rotating-positioning element has two positioning protrusions opposite to each other; and
the stationary-positioning element has two positioning recesses, and the detents in the positioning recesses are opposite to each other.

3. The hinge as claimed in claim 1, wherein
the shaft is non-circular in cross section;
the central hole of the stationary-positioning element is non-circular to correspond to the shaft and to mount the stationary-positioning element securely on the shaft; and
the through hole of the stationary bracket is non-circular to correspond to the shaft and to mount the stationary bracket securely on the shaft.

4. The hinge as claimed in claim 2, wherein
the shaft is non-circular in cross section;
the central hole of the stationary-positioning element is non-circular to correspond to the shaft and to mount the stationary-positioning element securely on the shaft; and
the through hole of the stationary bracket is non-circular to correspond to the shaft and to mount the stationary bracket securely on the shaft.

5. The hinge as claimed in claim 1, wherein
the shaft has
a first end;
a second end;
a head formed on the first end of the shaft; and
a sector protruding part formed on and extending radially out of the head; and
the rotating bracket has a protrusion formed on and extending out of the outer surface of the second leaf and selectively abutting the sector protruding part of the shaft.

6. The hinge as claimed in claim 4, wherein
the shaft has
a first end;
a second end;
a head formed on the first end of the shaft; and
a sector protruding part formed on and extending radially out of the head; and
the rotating bracket has a protrusion formed on and extending out of the outer surface of the second leaf and selectively abutting the sector protruding part of the shaft.

7. The hinge as claimed in claim 5, wherein
the shaft has an annular groove formed around the shaft near the second end of the shaft; and
the fastening element is a C-clip and engages with the annular groove of the shaft.

8. The hinge as claimed in claim 6, wherein
the shaft has an annular groove formed around the shaft near the second end of the shaft; and
the fastening element is a C-clip and engages with the annular groove of the shaft.

9. The hinge as claimed in claim 1, wherein
the rotating bracket has a through hole formed through the second leaf and communicating with the circular hole of the rotating bracket; and
the rotating-positioning element has a fastening protrusion formed on and extending axially out of the outer surface of the rotating-positioning element and corresponding to and engaging the through hole of the rotating bracket to mount the rotating-positioning element securely on the rotating bracket.

10. The hinge as claimed in claim 8, wherein
the rotating bracket has a through hole formed through the second leaf and communicating with the circular hole of the rotating bracket; and
the rotating-positioning element has a fastening protrusion formed on and extending axially out of the outer surface of the rotating-positioning element and corresponding to and engaging the through hole of the rotating bracket to mount the rotating-positioning element securely on the rotating bracket.

11. The hinge as claimed in claim 1, wherein the biasing member is a spring.

12. The hinge as claimed in claim 10, wherein the biasing member is a spring.
